(19) United States
(12) Patent Application Publication
(10) Pub. No.: US 2006/0265560 A1
(43) Pub. Date: Nov. 23, 2006

(54) Controlling access to a data medium

(76) Inventor: Jurgen Holger Titus Geerlings, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/556,282

(22) PCT Filed: May 10, 2004
(86) PCT No.: PCT/IB04/50623

§ 371 Date: Nov. 9, 2005

(30) Foreign Application Priority Data
May 14, 2003 (EP) 03101330.3

(51) Int. Cl. G06F 12/00

(52) U.S. Cl. 711/163

(57) ABSTRACT

This invention relates to a method of accessing a data medium implemented on a media device (20), which method includes the steps of receiving said data medium (22) on a media device; assigning a first identification code representing an ID of said data medium, when said data medium is received for the first time or reading said first identification code from said data medium; receiving a second identification code representing an ID of a proprietor of said data medium with first information about accessibility regarding content on said data medium: storing said first and second identification code with said first information about accessibility, and optionally storing a first password of said proprietor, if received; receiving a third identification code representing an ID of a user attempting to use said data medium; determining second information about accessibility based on at least one of said first, second and third identification codes and based on said first information about accessibility; and providing a first access to said data medium based on said second information about accessibility. Said method further includes the steps of receiving a second password; modifying said second information about accessibility based on said first password and the received second password; and providing a second access to said data medium based on said modified second information about accessibility. This allows reading, writing, and modification of content to/from said data medium on said media device to be controlled by various IDs, e.g. user ID, passwords, disc IDs.

The present invention relates to a method of accessing a data medium.

The present invention also relates to a computer system for performing the method.

The present invention further relates to a computer program product for performing the method.

Additionally, the present invention relates to a data medium.

Furthermore, the present invention relates to a media device.

US 2001/0037459 discloses an information playback apparatus and a method by which playback of a DVD can be restricted by means of a password stored in a flash ROM of the information playback apparatus. This allows a parental level to determine whether a playback process is executed in a normal mode or in a more restricted mode.

It is a problem for users of data media that, when unused by the users themselves, other persons can read content from said data media, modify content onto said data media, write new content and even delete content to/from said data media; consequently, it is a further problem to the user that he may not even be aware that his content is replicated, modified or even removed, e.g. moved and copied to another data medium, i.e. content may actually be stolen in this way from his data medium. This may infringe on copy rights or property rights of original creators or users, especially if content is used later on without the consent of the rightful proprietors.

Said data media are typically transportable items, such as a optical disc such as CD, DVD, Blu-Ray, a removable disc (floppy, hard disk), a smart card, a USB memory device or a similar data media having a similar purpose such as tapes, i.e. said data media are accessible outside and removable from a media device which are typically used to read content, i.e. play back or show content, modify content and write new content, i.e. record and remove content. These processes of playback or showing content, recording content, etc. are typically performed by said media device on which the user pressed play, record, etc. actually in order to deliberately read or alter, respectively, the physical content residing or to reside on his data medium.

The media devices performing said processes on said data media may be, for example, a video cassette recorder (VCR) or a tape recorder (both using a corresponding tape), a digital assistant (PDA), a DVD player which can access both CDs and DVDs, a personal computer using various disc types (floppy, removable hard disk), a PCMCIA card or a USB memory device. It is a further trend, as in the example of the DVD player which can play CDs and DVDs, that media devices can generally read and write more than one dedicated data medium; this is possible by means of additional interfaces (installed in or to said media devices) enabling access to further data media, e.g. a USB port installed in the personal computer allows reading and writing from/to said USB memory device. The latter further enhances the possibility for persons other than the proprietor of a data medium to alter, remove, etc. content from it. The widespread use of removable and connectable data media on different media devices further worsens said problems.

It is an object of the present invention to obviate the drawbacks of the prior art, and to secure the user rights regarding data media.

According to the present invention, this object is realized in that the method of accessing a data medium comprises the steps of:
receiving said data medium on a media device;
assigning a first identification code representing an ID of said data medium, when said data medium is received for the first time or reading said first identification code from said data medium;
receiving a second identification code representing an ID of a proprietor of said data medium with first information about accessibility regarding content on said data medium:
storing said first and second identification code with said first information about accessibility, and optionally storing a first password of said proprietor, if received;
receiving a third identification code representing an ID of a user attempting to use said data medium;
determining second information about accessibility based on at least one of said first, second and third identification codes and based on said first information about accessibility; and
providing a first access to said data medium based on said second information about accessibility.

In this way, the present invention enables a particular data medium to be identified to belong to a certain user. When a new data medium is provided in the media device, the second identification code, e.g. the user ID, may be associated with the first identification code, e.g. the disc ID. As an example, the user ID may be requested to be confirmed when the data medium is inserted in the media device, e.g. a media recorder or a playback device, for a subsequent time. The invention allows controlling access to the data medium, e.g. to prevent recording or playback of the data medium or to restrict access to the medium by unauthorized users.

Said media device and data medium, respectively, provide the same advantages and solve the same problems for the same reasons as described previously in relation to the method.

The invention will be explained in more detail below in connection with preferred embodiments and with reference to the drawings, in which:

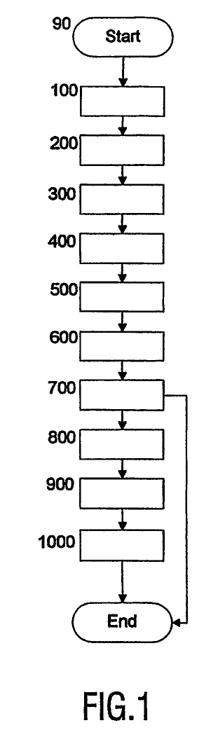

FIG. 1 shows a method of accessing a data medium; and

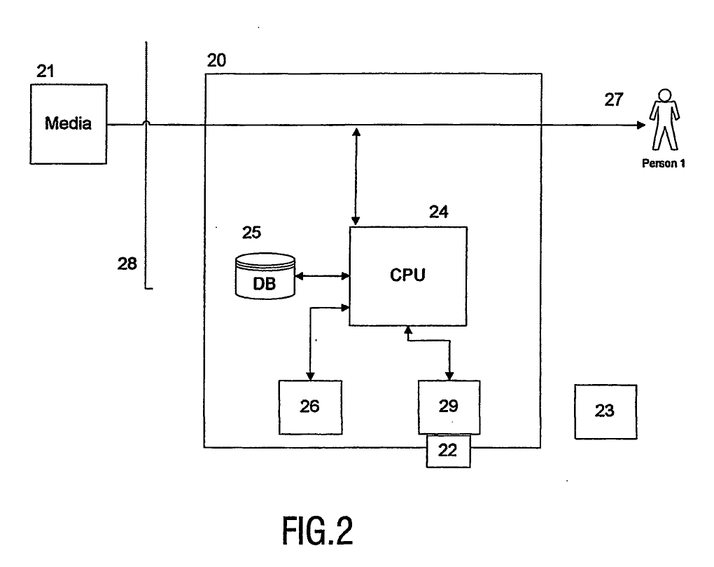

FIG. 2 shows a media device, the data medium and a computer-readable medium.

Throughout the drawings, the same reference numerals indicate similar or corresponding features, functions, etc.

FIG. 1 shows a method of accessing a data medium.

In step 100, said data medium is received on a media device. In order to start the method, said data medium may be placed in a tray, e.g. when said data medium is a DVD or a CD, it is to be positioned in the tray of the media device, e.g. a DVD player. As another example, when the data medium is a PCMCIA card, it is to be plugged in, i.e. connected to a corresponding PCMIA holder. Said holder may be embedded in a personal computer as the media device. As another example, when a USB memory device is the data medium, said USB memory device is to be plugged into a corresponding USB plug. Subsequently, in all cases, the media device will detect that it has received the data medium.

As an example, when a new disc is inserted in a recorder (as a media device) of discs (as data media), the recorder assigns a unique disc_ID to this disc.

The access rights, i.e. to allow reading, writing (play, record), etc. will be determined in the following steps.

In step 200, a first identification code representing an ID of said data medium is assigned. This is the case when said data medium is received for the first time. If not, said first identification code is read from said data medium instead. This is the case when said data medium has already had its (first) identification code assigned e.g. from previous use.

The reading or assignment will be performed by a processor belonging to said media device.

Continuing the example of the first-mentioned step, said unique disc_ID may be, for example, an ID already present on the disc or an ID that the recorder will generate and write on the disc when the disc is recorded for the first time.

The read or assigned first identification code for said data medium will be a unique disc ID, e.g. for a disc (as the data medium). In a corresponding manner, said first identification code would be a unique tape ID for a tape (as the data medium), while said first identification code would be an ID uniquely representing said USB memory device when the data medium is a USB memory device.

Said first identification code is unique, i.e. different from any other identification code, e.g. the next number available from a list of generated random numbers, the next number in a predefined number sequence having enough digits, so that it is unlikely that two assigned numbers (i.e. two first identification codes) are the same.

In step 300, a second identification code is received. It may correspond to a user ID of the proprietor, because it represents an ID of the proprietor of said data medium. Furthermore, first information representing accessibility is received with said second identification code. Said first information represents accessibility for content on said data medium. This applies to the present and further additional content.

In other words, in this step, the proprietor informs the media device about his user ID (i.e. the second identification code) and the access rights he grants to (the content of) this particular data medium, and the rights are represented by said first information which represents accessibility to the content on the data medium. The right(s) may be one of the following:
1) “read only” i.e. a content can be shown or played back
2) “write only” i.e. a content can only be recorded on the data medium
3) “read and write” corresponding to 1) and 2) are allowed; and
4) “no read and no write”, i.e. content may neither be shown nor played back, and is not allowed to be recorded on the data medium, in fact 4) will work as an intended prohibition of a right.

The reception of said second identification and said first information about accessibility will be performed by a processor embedded in said media device, when these items are provided by the user of the media device.

In summary, as a result of the above steps, the media device now has said first and second identification codes in its memory, where the latter is received from the user with said first information about accessibility.

Continuing the example of the previous steps, when said disc is recorded for the first time, the recorder will prompt the user to assign a user_ID (i.e. said second identification code) to this disc.

In step 400, said first and second identification code with said first information about accessibility are stored, and optionally a first password of said proprietor is stored, if the first password is also received.

The storing is performed by means of said media device and on said media device in a memory or a database and/or additionally by means of writing said codes and password onto said data medium.

In summary, as a result of the above steps, the media device now has said first and second identification codes with said first information about accessibility and said first password in its memory. Subsequently, another user (other than the proprietor) can now be recognized, because he will neither know the second identification code (user ID) nor said first password.

Continuing the example of the previous steps, the disc_ID and user_ID are stored in the memory. This memory allows a certain user to be associated with a certain disc. The memory may be inside the recorder, in which case the record/playback control will only be active if the disc is inserted in a certain recorder. Both disc_ID and user_ID can also be stored on the disc, in which case the access control can be used on various recorder and/or playback devices.

In step 500, a third identification code is received. It represents an ID of a person attempting to use said data medium. Said third identification code corresponds to a second user ID. The person now attempting to use said data medium, e.g. prior to any read or write process on/from the data medium, will be requested—by information shown e.g. on a display or the like on said media device—to provide his user ID, i.e. said third identification code.

Said third identification code will be received by a processor belonging to said media device, when said user ID is provided by the user attempting to use the data medium.

Said third identification code can of course be compared with said second identification code which corresponded to the (first) user ID identifying the rightful proprietor (of said data medium). This is one of the possibilities in the next step.

Continuing the example of the previous steps, the user_ID, i.e. said third identification code can also be used for playback control. If the user does not supply the correct user ID (i.e. said second user ID which, in fact, identified the rightful proprietor to said data medium), then playback will be prohibited as an end result in step 700. In all cases—as the next step—second information about accessibility is determined.

In step 600, said second information about accessibility is determined. It is based on at least one of said first, second and third identification codes and on said first information about accessibility. Said second information about accessibility is of the same structure as the previous said first information about accessibility, i.e. it may similarly determine “read only”, i.e. content can be shown or played back, alternatively, it may determine “write only”, i.e. content may only be recorded, or alternatively, it may determine “read and write” corresponding to full access, and, conversely and alternatively, it may determine “no read and no write”, i.e. content may neither be shown nor played back, which content is neither allowed to be recorded onto the data medium.

In other words, said second information about accessibility may be a restricted version of said first information about accessibility, i.e. limited rights, especially when the given said third identification code is not equal to said second identification code, i.e. the attempting user is not the rightful proprietor of (content on) said data medium. The limited right can then be “read only”, “write only” or more likely “no read and no write”, i.e. in the latter case, the attempting user can neither have content played back/shown nor recorded on/from the data medium.

In one of the embodiments of the present invention, the second accessibility information may be determined by taking into account a relationship between the second identification code (the first user_ID) and the third identification code (the second user_ID), e.g. the first user and the second user may belong to a community of users wherein each user has the same limited access rights (the second accessibility information) and, for example, one or few users have an exclusive full access right. For instance, the users who do not belong to the community may not have any access rights to the data medium at all. As an example, a data medium belonging to a user of a family may also be accessed in the same or limited way by the other members of the family.

In one embodiment of the present invention, when the first identification code (giving the ID of the data medium and read from it in step 100) is found to be unknown to the media device, this data medium cannot be used with the media device, i.e. no access rights are granted. This will then be reflected in the determined second information about accessibility, i.e. “no read and no write”.

The proprietor may deliberately and initially determine that only a limited access right, e.g. “read only”, was provided by means of the initially given first information about accessibility. Consequently—even the user (himself) providing the correct second and third identification codes, i.e. which are provided to be equal—will be confronted with the limited right of “read only”. This, of course, will also be reflected in the subsequently determined second information about accessibility.

In general, the determination of said second information about accessibility is based on one or more of said first, second and third identification codes and also on said first information about accessibility.

Copy rights or property rights of original creators or users (of content on said data media) are thereby secured.

In step 700, a first access to said data medium is provided. It is based on said second information about accessibility. The determined second information about accessibility from the previous step here provides the subsequent (first) access right to said data medium, i.e. said data medium is only allowed to be read, or said data medium is only allowed to be written on, or no access to said data medium is provided at all, or, conversely, all operations are allowed, i.e. allowing read and write when a playback function and a record function, respectively, are attempted. As is known in the art, “write” may also typically imply the right to delete data or content, because deletion can be understood as writing of other data or content instead.

A user attempting to record or play back will then be allowed to do so if it is possible according to said (first) access right to said data medium. If it is not possible, the user will see a displayed message informing him of what is solely possible.

Assuming that the user tries to record (on a DVD as the data medium) on a DVD recorder, but only has a “read only” right access (i.e. it is his determined particular first access to said data medium), a message saying: “you are only allowed to playback this DVD, recording is not possible”, or a similar message will be displayed to him.

As another example, assuming that another user now tries to play back a CD not belonging to him, i.e. the user now attempting to use the CD has no rights at all to this CD, a message (from the CD player as the media device) saying: “this is apparently not your CD, it cannot be accessed at all” or a similar message will be displayed to him.

As an option, said method further comprises the following three steps.

In step 800, a second password is received. Said password will be received by a processor embedded in said media device, when said password is provided by the current user of the media device.

As an enhancement of the security level, said second password is further considered in the determination of said second information about accessibility, as is the case in the next step.

In step 900, said second information about accessibility is modified. It is based on said first password and the received second password. The newly determined second information about accessibility is of course also based on the old second information about accessibility and on the outcome of a comparison between first and second passwords. If they are equal, said second information about accessibility may be left unmodified, otherwise said second information about accessibility may be modified to provide fewer or no rights, i.e. the modified second information about accessibility could determine “no read and no write”, i.e. no access rights at all.

In step 1000, a second access to said data medium is provided. It is based on said modified second information about accessibility. This step corresponds to step 700, i.e. here said second access is applied instead of said first access.

Continuing the example of the previous steps, the recorder can interrogate the user to determine whether this user has rights to record or play back on this disc, for example by requesting a user-specific password, e.g. a PIN code as discussed in step 800, i.e. said second password. If this password is not supplied at all or supplied incorrectly, the recorder will prohibit the recording on this disc, and/or the recorder will prohibit playback from this disc, i.e. said second access will determine a very limited access or even no access to said data disc.

By means of the three optional steps mentioned above, a further security level is reached, because more IDs are considered, i.e. in the set of passwords and user ID,—as another example of an embodiment of the invention—each (i.e. per set) has to be equal to provide access with most rights.

In a corresponding manner, if the proprietor originally provided full access, i.e. all rights, e.g. “read” and “write” (still corresponding to said first information about accessibility regarding content on said data medium which may be equal to said second information about accessibility), these rights may still apply. In this case, content can both be played back from the data medium, and another content is also allowed to be recorded onto the data medium. Of course, this is only the case when the set of user IDs and the set of passwords were provided satisfactorily, i.e. being equal in each set. This, of course, indicates that, in fact, the proprietor is accessing his own data medium.

Conversely, by means of the three optional steps mentioned above, a further security level is applied to stop unauthorized users. The unauthorized user will be caught in providing wrong IDs, i.e. when in the set of provided passwords and user IDs, each (i.e. per set) is unequal, a very limited access will subsequently be provided, i.e. either a limited access or no access at all to the content on the data medium.

It should be noted that the invention is not restricted to the user providing the second identification code, third identification code, etc. but that, for example, different user recognition techniques such as face recognition, user voice identification, fingerprint recognition may be used for automatically determining the user_ID, e.g. using data for identifying user_ID based on the fingerprint, voice input, etc.

In one of the embodiments of the present invention, a history of attempts to access a particular data medium may be recorded in the media device or on the data medium itself. This may be particularly useful, for example, to inform the user having access to the data medium about attempts by other users to access said medium.

FIG. 2 shows a media device, the data medium and a computer-readable medium. The media device implements the method of FIG. 1. Reference numeral 20 denotes the media device, reference numeral 22 denotes the data medium and reference numeral 23 denotes the computer-readable medium on which said method comprising the program code is stored.

Reference numeral 21 may denote a media provider providing content. Reference numeral 21 may denote more than one media provider. Content may be a live content like a TV program, a video available for view on demand, an interactive live TV broadcast on the Internet, Internet TV, Internet sites, a movie, radio broadcasts or any other content which can be watched and possibly stored subsequently, i.e. recorded on a data medium suitable for later playback and presentation on said media device. Content may also be provided in simpler forms, such as plain text (e.g. an article, a description), numerical data (e.g. a spreadsheet), etc. In more technical terms, content comprises, for example, one or more selected from the group of:
a DVD MPEG Program Stream containing picture and sound signal;
a Blu-Ray MPEG Transport Stream containing picture and sound signal;
a CD sound signal, a text, spreadsheet data;
a given digital audio format (e.g. MP3, WMA, Real Audio, WAV, etc.);
a given digital movie format (e.g. DivX, DVD/MPEG2, Avi, wmf, MOV, Real Video, etc.);
a given picture format (e.g. JPEG, GIF, BMP, TIFF, etc.); and/or
any such format that is capable of causing the device to supply a picture, a description and/or sound signal, e.g. G72x, aiff, real.

Typically, content is contained in a file which can be stored on said data medium.

Reference numeral 24 may denote the CPU or the processing power of the media device.

Reference numeral 24 may update reference numeral 25, a database or memory with IDs such as user password, user IDs, ID of the data medium, etc. Additionally or alternatively, these are written on said data medium.

Generally, reference numeral 20 may denote a device that can present the content either live or from a recorded data medium. The media device may further have a CPU or another processing power in that it may respond to various user inputs. The user's response may be given by input means, reference numeral 26. The input means may be a keyboard, a mouse, a remote control, an interactive menu with clicks on an onscreen menu, a joystick, simple push buttons, or by means of selections on a graphical user interface. It may be used, for example, to receive various IDs, e.g. user password(s), user IDs, etc.

Said user input may further be used to generate content, e.g. typed content. In this case, content could be text from a word-processor application and/or data from a spreadsheet application, etc. Additionally, user input may be used to retrieve and/or manipulate content. Content can further be retrieved, i.e. read from one data medium before possible storage of (recording on) another data medium, possibly a different data medium, i.e. a data medium of a different type.

Reference numeral 27 denotes one or more users of the media device. The user or users may watch or listen to the presented and or selected content. Furthermore, the user may attempt to play back or record content to/from said recorded data medium. As discussed in the previous Figure, the media device may restrict or provide access to content from said recorded data medium. As also discussed, various identification codes (first, second, third) and first and second information items about accessibility were used in order to determine access rights of said data medium. Said input means is used to receive said identification codes and information items, when provided by the user of the media device.

Said data medium may be placed in a tray, denoted by reference numeral 29, e.g. for a DVD or a CD as the data medium. It is to be positioned in the tray of a media device such as a DVD player. As another example, a PCMCIA card as the data medium is to be connected to a corresponding holder. Said holder may be embedded in a personal computer as the media device. As another example, a USB memory device as the data medium is to be plugged into a USB plug. As discussed, reference numeral 22 denotes the data medium, which is generally placed, positioned or plugged into said tray, holder, plug, etc., denoted by reference numeral 29.

Reference numeral 28 denotes the user connection point to the media provider 21. It may be an antenna outlet for TV or radio, a modem or ADSL connection or a similar connection to the Internet, an antenna outlet from a satellite receiver, a SCART connection to a TV and/or to a VCR, an additional USB plug, a Bluetooth or IR interface, etc.

Generally, said data medium may be a magnetic tape, an optical disc, a digital versatile disk (DVD), a compact disc (CD recordable or CD writable), a mini-disc, a hard disk, a floppy disk, a smart card, a PCMCIA card, a USB memory device, a VCR tape, a tape, etc. Typically, said hard disk will be easily removable, i.e. it can easily be applied in e.g. another personal computer or another electronic device which is capable of reading/writing data (content) to/from said hard disk. The same applies to the other examples of data medium types.

In a corresponding manner, said data medium may have content read from and/or written to it by means of various media devices, i.e., for example, a video cassette recorder (VCR), a tape recorder, a personal digital assistant (PDA), a mobile phone, a television, a DVD player, a CD player or a personal computer.

A computer-readable medium may be a magnetic tape, an optical disc, a digital versatile disk (DVD), a compact disc (CD recordable or CD writable), a mini-disc, a hard disk, a floppy disk, a smart card, a PCMCIA card, etc.

In the claims, any reference signs placed between parentheses shall not be constructed as limiting the claim. Use of the verb “comprise” and its conjugations does not exclude the presence of elements or steps other than those stated in a claim. Use of the indefinite article “a” or “an” preceding an element or step does not exclude the presence of a plurality of such elements or steps.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of accessing a data medium, said method comprising the steps of:
receiving (100) said data medium (22) on a media device (20);
assigning (200) a first identification code representing an ID of said data medium, when said data medium is received for the first time or reading said first identification code from said data medium;
receiving (300) a second identification code representing an ID of a proprietor of said data medium with first information about accessibility regarding content on said data medium:
storing (400) said first and second identification code with said first information about accessibility, and optionally storing a first password of said proprietor, if received;
receiving (500) a third identification code representing an ID of a user attempting to use said data medium;
determining (600) second information about accessibility based on at least one of said first, second and third identification codes and based on said first information about accessibility; and
providing (700) a first access to said data medium based on said second information about accessibility.

2. A method as claimed in claim 1, said method further comprising the steps of:
receiving (800) a second password;
modifying (900) said second information about accessibility based on said first password and the received second password; and
providing (1000) a second access to said data medium based on said modified second information about accessibility.

3. A method as claimed in claim 1, characterized in that said storing of said first and second identification codes with said first information about accessibility, and storing of said first password are performed on said media device in a memory or a database (25) and/or on said data medium.

4. A method as claimed in claim 1, characterized in that said content comprises one or more selected from the group:
a DVD MPEG Program Stream containing picture and sound signal;
a Blu-Ray MPEG Transport Stream containing picture and sound signal;
a CD sound signal, a text, spreadsheet data;
a given digital audio format (e.g. MP3, WMA, Real Audio, WAV, etc.);
a given digital movie format (e.g. DivX, DVD/MPEG2, Avi, wmf, MOV, Real Video, etc.);
a given picture format (e.g. JPEG, GIF, BMP, TIFF, etc.); and/or
any such format that is capable of causing the device to emit a picture, a description and/or sound signal, e.g. G72x, aiff, real.

5. A method as claimed in claim 1, characterized in that each of said first and second information about accessibility comprises one of “read only”, “write only”, “read and write”, and “no read and no write”.

6. A method as claimed in claim 1, characterized in that said media device is a video cassette recorder (VCR), a tape recorder, a personal digital assistant (PDA), a mobile phone, a television, a DVD player or recorder, a CD player or recorder, or a personal computer.

7. A method as claimed in claim 1, characterized in that said data medium is a magnetic tape, an optical disc, a digital versatile disk (DVD), a Blu-Ray disc (BD), a compact disc (CD recordable or CD writable), a mini-disc, a removable hard disk, a floppy disk, a smart card, a PCMCIA card, a USB memory device, a VCR tape or a tape.

8. A media device (20) comprising:
means for receiving said data medium (22);
means for assigning a first identification code representing an ID of said data medium, when said data medium is received for the first time or reading said first identification code from said data medium;
means for receiving a second identification code representing an ID of a proprietor of said data medium with first information about accessibility regarding content on said data medium:
means for storing said first and second identification code with said first information about accessibility, and optionally storing a first password of said proprietor, if received;
means for receiving a third identification code representing an ID of a user attempting to use said data medium;
means for determining second information about accessibility based on at least one of said first, second and third identification codes and based on said first information about accessibility; and
means for providing a first access to said data medium based on said second information about accessibility.

9. A media device as claimed in claim 8, further comprising:
means for receiving a second password;
means for modifying said second information about accessibility based on said first password and the received second password; and
means for providing a second access to said data medium based on said modified second information about accessibility.

10. A data medium (22) comprising a first identification code representing an ID of said data medium, a second identification code representing an ID of a proprietor of said data medium with first information about accessibility regarding content on said data medium, writable to said data medium and readable from said data medium.

11. A computer system for performing the method as claimed in claim 1.

12. A computer program product comprising program code means stored on a computer-readable medium (23) for performing the method of claim 1 when the computer program is run on a computer.
